(19) United States
(12) Patent Application Publication
(10) Pub. No.: US 2005/0169549 A1
(43) Pub. Date: Aug. 4, 2005

(54) Method and apparatus for scalable video coding and decoding

(75) Inventors: Sang-chang Cha, Hwaseong-si (KR); Woo-jin Han, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/045,329

(22) Filed: Jan. 31, 2005

(30) Foreign Application Priority Data
Jan. 31, 2004 (KR) 10-2004-0006479

(51) Int. Cl. G06K 9/36

(52) U.S. Cl. 382/240; 382/236

(57) ABSTRACT

Provided are a method and apparatus for scalable video coding and decoding. The scalable video coding method performs video coding separately at each resolution, and coding results are incorporated into one resolution level for compression. The scalable video coding combines images with the respective images into a single one while providing high image quality across all resolution levels.

### CROSS-REFERENCE TO RELATED APPLICATION

This application claims priority from Korean Patent Application No. 10-2004-0006479 filed on Jan. 31, 2004, in the Korean Intellectual Property Office, the disclosure of which is incorporated herein by reference in its entirety.

### BACKGROUND OF THE INVENTION

1. Field of the Invention

The present invention relates to a scalable video coding and decoding method and a scalable video encoder/decoder.

2. Description of the Related Art

A compression coding method is requisite for transmitting multimedia data, including text, video, and audio, since the amount of multimedia data is usually large.

A basic principle of data compression lies in removing data redundancy. Data can be compressed by removing spatial redundancy in which the same color or object is repeated in an image, temporal redundancy in which there is little change between adjacent frames in a moving image or the same sound is repeated in audio, or mental visual redundancy taking into account human eyesight and dull perception of high frequency information. Data compression can be classified into lossy/lossless compression depending on whether source data is lost, intraframe/interframe compression depending on whether individual frames are compressed independently, and symmetric/asymmetric compression depending on whether time required for compression is the same as the time required for recovery. In addition, data compression is defined as real-time compression when a compression/recovery time delay does not exceed 50 ms and as scalable compression when frames have different resolution levels. For text or medical data, lossless compression is usually used. For multimedia data, lossy compression is usually used. Meanwhile, intraframe compression is usually used to remove spatial redundancy, and interframe compression is usually used to remove temporal redundancy.

Recently, research into wavelet-based scalable video coding, which can provide a very flexible, scalable bitstream, has been actively carried out. The scalable video coding means a video coding method having scalability. Scalability indicates the ability to partially decode a single compressed bitstream. Scalability includes spatial scalability indicating a video resolution, Signal to Noise Ratio (SNR) scalability indicating a video quality level, temporal scalability indicating a frame rate, and a combination thereof.

Among many techniques used for wavelet-based scalable video coding, motion compensated temporal filtering (MCTF) that was introduced by Jens-Rainer Ohm and improved by Seung-Jong Choi and John W. Woods is an essential technique for removing temporal redundancy and for video coding having flexible temporal scalability.

FIG. 1A shows a motion compensated temporal filtering (MCTF)-based scalable video encoder.

Referring to FIG. 1A, the scalable video encoder receives a plurality of frames making up a video sequence and compresses the frames in units of group of pictures (GOP) to generate a bitstream. To achieve this function, the scalable video encoder includes a temporal transform unit 110 removing temporal redundancies from the plurality of frames, a spatial transform unit 120 removing spatial redundancies, a quantizer 130 quantizing transform coefficients created by removing the temporal and spatial redundancies, and a bitstream generator 140 combining the quantized transform coefficients and other information into a bitstream.

The temporal transform unit 110 includes a motion estimator 112 and a temporal filter 114 in order to perform temporal filtering by compensating for motion between frames. The motion estimator 112 calculates a motion vector between each block in a current frame being subjected to temporal filtering and its counterpart in a reference frame. The temporal filter 114 that receives information about the motion vectors performs temporal filtering on the plurality of frames using the information.

A spatial transform unit 120 uses a wavelet transform to remove spatial redundancies from the frames from which the temporal redundancies have been removed, i.e., temporally filtered frames. The spatial transform unit 120 removes spatial redundancies from the frames using a wavelet transform. In a currently known wavelet transform, a frame is decomposed into four sections (quadrants). A quarter-sized image (L image), which is substantially the same as the entire image, appears in a quadrant of the frame, and information (H image), which is needed to reconstruct the entire image from the L image, appears in the other three quadrants. In the same way, the L image may be decomposed into a quarter-sized LL image and information needed to reconstruct the L image.

The temporally filtered frames are converted to transform coefficients by spatial transformation. The transform coefficients are then delivered to a quantizer 130 for quantization. The quantizer 130 quantizes the real-number transform coefficients with integer-valued coefficients. The MCTF based video encoder uses an embedded quantization technique. By performing embedded quantization on transform coefficients, it is possible to not only reduce the amount of information to be transmitted but also achieve signal-to-noise ratio (SNR) scalability. Embedded quantization algorithms currently in use are embedded zero-tree wavelet (EZW), set partitioning into hierarchical trees (SPIHT), embedded zero block coding (EZBC), and embedded block coding with optimized truncation (EBCOT).

The bitstream generator 140 generates a bitstream containing coded image data, the motion vectors obtained from the motion estimator 112, and other necessary information.

The scalable video coding method includes a method of performing a spatial transform (i.e., a wavelet transform) on frames and then performing a temporal transform, which is called an in-band scalable video coding.

FIG. 1B shows an in-band scalable video encoder in which frames are subjected to spatial transform (wavelet transform) followed by temporal transform.

Referring to FIG. 1B, the in-band scalable video encoder is designed to remove temporal redundancies that exist within a plurality of frames making up a video sequence after removing spatial redundancies.

A spatial transform unit 150 performs a wavelet transform on each frame in order to remove spatial redundancies among the frames.

A temporal transform unit 160 includes a motion estimator 162 and a temporal filter 164 and performs temporal filtering on the frames from which the spatial redundancies have been removed in a wavelet domain in order to remove temporal redundancies.

A quantizer 170 quantizes transform coefficients obtained by removing spatial and temporal redundancies from the frames.

A bitstream generator 180 generates a bitstream from motion vectors and coded image subjected to quantization.

FIG. 2A is a diagram for explaining an MCTF process used in a scalable video coding algorithm to remove temporal redundancies while maintaining temporal scalability.

Referring to FIG. 2A, an L frame is a low frequency frame corresponding to an average of frames while an H frame is a high frequency frame corresponding to a difference between frames. In the illustrated coding process, pairs of frames at a low temporal level are temporally filtered and then decomposed into pairs of L frames and H frames at a higher temporal level, and the pairs of L frames are again temporally filtered and decomposed into frames at a higher temporal level.

An encoder performs wavelet transformation on one L frame at the highest temporal level and the H frames and generates a bitstream. Frames indicated by shading in FIG. 2A are the ones that are subjected to a wavelet transform. That is to say, the coding is performed in an order from lower level frames to higher level frames.

On the other hand, a decoder performs an inverse operation to the encoder on the frames indicated by shading and obtained by inverse wavelet transformation from a high level to a low level for reconstructions. L and H frames at temporal level 3 are used to reconstruct two L frames at temporal level 2, and the two L frames and two H frames at temporal level 2 are used to reconstruct four L frames at temporal level 1. Finally, the four L frames and four H frames at temporal level 1 are used to reconstruct eight frames. While the MCTF-based video coding scheme basically offers flexible temporal scalability, it still has several disadvantages, including unidirectional motion estimation and poor performance at a low temporal rate, which is described in several publications. One among the publications is disclosed by Woo-Jin Han (co-inventor of the present invention) in ISO/IEC JTC 1/SC 29/WG 11, entitled Successive Temporal Approximation and Referencing (STAR) for improving MCTF in Low End-to-end Delay Scalable Video Coding. The STAR will be described with reference to FIG. 2B.

FIG. 2B is a diagram for explaining a temporal filtering process in a successive temporal approximation and referencing (STAR) algorithm. In FIG. 2B, ‘I’ frame and ‘H’ frame denote an intracoded frame (encoded without reference to another frame) and a high frequency subband encoded with reference to one or more frames.

Like a MCTF algorithm, a STAR algorithm is designed to remove temporal redundancies while maintaining temporal scalability at a decoder side. However, both coding and decoding processes in the STAR algorithm are performed in the order of highest to lowest temporal level. Referring to FIG. 2B, coding and decoding are all performed in the order of numbers 0, 4, 2, 6, 1, 3, 5, and 7. Furthermore, unlike MCTF, STAR has a multi-reference function. The requirement for maintaining temporal scalability at encoder and decoder sides while using the multi-reference function is defined by:
Rₖ={F(l)|(T(l)>T(k)) or ((T(l)=T(k))and (l<=k))}
where F(k) and T(k) respectively denote a frame with index k and its temporal level and k and I respectively denote indices of a frame currently being encoded and of frames being referenced.

Referring to FIG. 2B, frames may be encoded with reference to themselves, which is useful for rapidly varying video sequences. Encoding and decoding processes using the STAR algorithm may be performed as follows:

Encoding Process
1. A first frame in a GOP is encoded as an I-frame.
2. Then, motion estimation is performed on frames at the next temporal level, followed by encoding using reference frames defined by Equation (1). Within the same temporal level, encoding is performed starting from the leftmost frame toward the rightmost (in order from the lowest to the highest index frame).
3. The step (2) is performed until all frames in the GOP are encoded. Subsequent encoding of frames in the next GOP continues until encoding of all GOPs is finished.

Decoding Process
1. A first frame in a GOP is decoded.
2. Frames at the next temporal level are decoded with reference to previously decoded frames. Within the same temporal level, decoding is performed starting from the leftmost frame toward the rightmost (in order from the lowest to the highest index frame).
3. The step (2) is performed until all frames in the GOP are decoded. Subsequent decoding of frames in the next GOP continues until decoding of all GOPs is finished.

MCTF and STAR algorithms are all designed to remove temporal redundancies, followed by wavelet transform to remove spatial redundancies. Removal of temporal redundancies using motion compensation will now be described with reference to FIG. 3. FIG. 3 is a diagram for explaining wavelet-based video coding supporting spatial scalability.

Wavelet-based video coding involves generating a residual image by subtracting referred images created using one or more referenced images from an original image and then performing wavelet transform and quantization on the generated residual image to obtain a coded image. Referring to FIG. 3, a wavelet-based video encoder supporting three spatial layers generates a bitstream including three layers of coded images and information (motion vectors) used to create three layers of referred images for each frame.

More specifically, the encoder downsamples an original image O₁ of layer L1 to produce an original image O₂ of layer L2. Similarly, the encoder downsamples the original image O₂ of layer L2 to produce an original image O₃ of layer L3. The encoder uses one or more referenced images to produce a referred image R₁ of layer L1 for temporal filtering of the original image O₁. In the same manner, the encoder produces referred images R₂ and R₃ of layers L1 and L2, respectively, using one or more referenced images for temporal filtering of the original images O₂ and O₃. Each of the referred images R₁, R₂, and R₃ is generated using motion estimation between each of the original images O₁, O₂, and O₃ and each referenced image having temporal difference from the corresponding original image O₁, O₂, or O₃. The encoder then produces residual images E₁, E₂, and E₃ by respectively subtracting the referred images R₁, R₂, and R₃ from the original images O₁, O₂, and O₃. The encoder performs wavelet transform and quantization on the residual images E₁, E₂, and E₃ to obtain coded images with the respective layers L1, L2, and L3. The coded images with the respective layers L1, L2, and L3 and information on estimated values (values of motion vectors) used to create referred images R₁, R₂, and R₃ are combined into a bitstream.

A decoder that receives the bitstream is able to reconstruct the original video sequence composed of images having desired resolution. That is, the decoder pre-decodes a bitstream or receives a pre-decoded bitstream to reconstruct images having desired resolution among the layers L1, L2, and L3. However, in the wavelet-based video coding, the encoder generates the bitstream containing all coded image data and information on estimated motion vectors for the three layers L1, L2, and L3. That is, since the bitstream contains a great deal of redundant information on similar images, video coding efficiency is degraded.

Another video encoder designed to increase the coding efficiency generates a bitstream containing information used to create the referred image R₁ having the highest resolution and coded image having the highest resolution, as opposed to a wavelet-based video encoder to generate a bitstream having information on a lower-resolution image incorporated into a high resolution image. However, actually, the values of motion vector values used to derive the referred images R₁, R₂, and R₃ with the respective layers L1, L2, and L3 is actually similar but not identical. Thus, the encoder estimates the motion of a lower-resolution image with motion vectors for the highest resolution image, compared to an optimal estimation, which degrades the quality of the residual image E2 or E3. In particular, this causes serious degradation of quality of the lowest resolution residual image E₃. Allocation of more bits for the residual image E₃ during encoding may solve this problem but incurs degradation in compression efficiency.

Meanwhile, the in-band scalable video encoder of FIG. 1B can provide high quality, low-resolution images by performing motion estimation and temporal filtering on images subjected to a wavelet transform. However, in-band video coding has a problem in that the quality of an image reconstructed at the decoder side is lower than those provided by other techniques described above because it requires temporal filtering in the wavelet domain.

One of various approaches developed to solve these problems is disclosed in a paper presented by NEC Corp. [“Multi-Resolution MCTF for 3D Wavelet Transformation in Highly Scalable Video”, ISO/EEC JTC1/SC29/WG11, July 2003]. According to the paper, by replacing a high resolution low subband with a low-resolution image at the encoder side, it is possible to effectively contain information ranging from highest to lowest resolution in the highest resolution coded image. As for estimated values, the bitstream contains only motion vectors used to derive the highest resolution referred image. At the decoder side, a drift error compensation filter is used. According to this algorithm, a significant percentage of lower resolution information can be contained in a high resolution coded image by inserting a lower-resolution image into the high resolution image. However, the use of only motion vectors for the high resolution image provides lower performance than expected. Therefore, it is highly desirable to have a video coding algorithm providing high image quality at all resolution levels while reducing redundant information as much as possible.

### SUMMARY OF THE INVENTION

The present invention provides a method and apparatus for video coding and decoding designed to provide high image quality at all resolution levels while reducing redundancy in a coded image with each resolution.

According to an aspect of the present invention, there is provided a scalable video coding method comprising performing low-passing filtering on each of original-resolution images in a video sequence to generate lower-resolution images corresponding to the original-resolution images and removing temporal redundancies from the original-resolution images and the lower-resolution images to generate original-resolution residual images and lower-resolution residual images, performing a wavelet transform on the original-resolution residual images and lower-resolution residual images to respectively generate an original-resolution transformed images and lower-resolution transformed images and combining the lower-resolution transformed images into the original-resolution transformed images to generate unified original-resolution transformed images, and quantizing each of the unified original-resolution transformed images to generate coded image data and generating a bitstream containing the coded image data and motion vectors obtained while removing the temporal redundancies from the original-resolution images and the lower-resolution images.

Here, the low-pass filtering is preferably performed by downsampling using a wavelet 9-7 filter.

The generated lower-resolution images may include first low-resolution images obtained by low-pass filtering each of the original-resolution images and second low-resolution images obtained by low-pass filtering the first low-resolution images. Here, the original-resolution images and the first and second low-resolution images are respectively converted into original-resolution transformed images and first and second low-resolution transformed images after removing the temporal redundancies therefrom, among which the first and second low-resolution transformed images are then combined together to generate unified first low-resolution transformed images, and the original-resolution transformed images and the unified first low-resolution transformed images are combined together to generate unified original-resolution transformed images.

The removing of temporal redundancies may be performed by each resolution level, and may comprise performing motion estimation on each resolution image to find motion vectors to be used in removing temporal redundancies from the image by referencing one or more original images corresponding to one or more coded images, and removing temporal redundancies from the images by performing motion compensation using the motion vectors obtained by the motion estimation to generate residual images.

The referenced images corresponding to the coded images may be obtained by decoding the coded images.

The scalable video coding method may further comprise referencing the residual images when temporal redundancies of the residual images themselves are removed.

According to another aspect of the present invention, there is provided a scalable video encoder comprising a temporal redundancy remover removing temporal redundancies from each of original-resolution images and lower-resolution images corresponding to the original-resolution image and generating original-resolution residual images and lower-resolution residual images, a spatial redundancy remover performing a wavelet transform on the original-resolution residual images and lower-resolution residual images to respectively generate original-resolution transformed images and lower-resolution transformed images and combining the lower-resolution transformed images into the original-resolution transformed image to generate unified original-resolution transformed images, and a quantizer quantizing each of the unified original-resolution transformed images to generate coded image data, and a bitstream generator generating a bitstream containing the coded image data and motion vectors obtained while removing the temporal redundancies from the original-resolution images and the lower-resolution images.

The encoder may further comprise a plurality of low-pass filter performing low-pass filtering on each of the original-resolution images to generate the lower-resolution images.

The generated lower-resolution images may include first low-resolution images obtained by low-pass filtering each of the original-resolution images and second low-resolution images obtained by low-pass filtering the first low-resolution images. Here, the original-resolution images and the first and second low-resolution images are respectively converted into the original-resolution transformed images and the first and second low-resolution transformed images by the spatial redundancy remover after the temporal redundancy remover removes the temporal redundancies therefrom, among which the first and second low-resolution transformed images are then combined together to generate unified first low-resolution transformed images, and the original transformed images and the unified first low-resolution transformed images are combined together to generate unified original-resolution transformed images.

The temporal redundancy remover removing temporal redundancies for each resolution image may comprise one or more motion estimators finding motion vectors to be used in removing temporal redundancies from each image by referencing one or more original images corresponding to the one or more coded images, and one or more motion compensators performing motion compensation on each image using the motion vectors obtained by the motion estimation to generate residual images.

The encoder may further comprise a decoding unit reconstructing original images by decoding the coded images, wherein the referenced images corresponding to the coded images are obtained by decoding the coded images by the decoding unit.

The temporal redundancy remover may further comprise one or more intra-predictors removing temporal redundancies from each image with reference to the image itself.

The spatial redundancy remover may comprise one or more wavelet transform units performing a wavelet transform on the original-resolution residual images and the lower-resolution residual images to respectively generate the original-resolution transformed images and the lower-resolution transformed images and a transformed image combiner that unifies the lower-resolution transformed images into the original-resolution transformed images to generate unified original-resolution transformed images.

According to still another aspect of the present invention, there is provided a scalable video decoding method comprising extracting coded image data from a bitstream, and separating and inversely quantizing the coded image data to generate unified original-resolution transformed images and lower-resolution transformed images corresponding to the unified original-resolution transformed images, performing an inverse wavelet transform on each of the unified original-resolution transformed images and its lower-resolution transformed images to generate unified original-resolution residual images and lower-resolution residual images, and performing inverse motion compensation on the lower-resolution residual images using lower-resolution motion vectors extracted from the bitstream to reconstruct lower-resolution images and reconstructing original-resolution images from the unified original-resolution residual images using original-resolution motion vectors extracted from the bitstream.

The generated lower-resolution transformed images may include unified first low-resolution transformed images and second low-resolution transformed images corresponding to the unified first low-resolution transformed images. Also, the unified original-resolution images, the unified first low-resolution transformed images, and the second low-resolution transformed images are subjected to the inverse wavelet transform to respectively generate unified original-resolution residual images, unified first low resolution residual images, and second low resolution residual images, and inverse motion compensation is performed on the second low resolution residual images using second low-resolution motion vectors obtained from the bitstream to reconstruct second low-resolution images and then first low-resolution images are reconstructed from the unified first low resolution residual images using first low-resolution motion vectors extracted from the bitstream.

The performing of the inverse motion compensation may comprise reconstructing lower-resolution images by performing inverse motion compensation on the lower-resolution residual images using the lower-resolution motion vectors, generating original-resolution high frequency residual image from each of the unified original-resolution residual images using the lower-resolution residual images, generating each of original-resolution residual images using referred images created by the inverse motion compensation of the original resolution using the original-resolution motion vectors and the reconstructed lower-resolution images, and reconstructing original-resolution images by performing inverse motion compensation on the original-resolution residual images using the original-resolution motion vectors.

According to a further aspect of the present invention, there is provided a scalable video decoding method comprising extracting coded image data from a bitstream, and separating and inversely quantizing the coded image data to generate original-resolution high-frequency transformed images and lower-resolution transformed images corresponding to the original-resolution high-frequency transformed images, performing an inverse wavelet transform on each of the original-resolution high-frequency transformed images and its lower-resolution transformed images to generate original-resolution high frequency residual images and lower-resolution residual images, and performing inverse motion compensation on the lower-resolution residual images using lower-resolution motion vectors extracted from the bitstream to reconstruct lower-resolution images, generating original-resolution residual images from the original high frequency residual images using the reconstructed lower-resolution images, and performing inverse motion compensation on the original-resolution residual images using original-resolution motion vectors extracted from the bitstream to reconstruct original-resolution images.

According to another aspect of the present invention, there is provided a scalable video decoder comprising a bitstream interpreter interpreting a received bitstream and extracting coded image data and motion vectors for an original resolution and lower resolution levels from the bitstream, an inverse quantizer separating and inversely quantizing the coded image data to generate unified original-resolution transformed images and lower-resolution transformed images corresponding to the unified original-resolution transformed images, an inverse spatial redundancy remover performing an inverse wavelet transform on each of the unified original-resolution transformed images and its lower-resolution transformed images to generate unified original-resolution residual images and lower-resolution residual images, and an inverse temporal redundancy remover performing inverse motion compensation on the lower-resolution residual images using the lower-resolution motion vectors extracted from the bitstream to reconstruct lower-resolution images and reconstructing original-resolution images from the unified original-resolution residual images using the reconstructed lower-resolution images and the original-resolution motion vectors extracted from the bitstream.

The inverse temporal redundancy remover may comprise one or more inverse motion compensators performing inverse motion compensation on each of the residual images using the original-resolution or lower-resolution motion vectors, one or more inverse low-pass filters increasing the resolution levels of the images, and one or more low-pass filters decreasing the resolution levels of the images. Here, the lower-resolution residual images are reconstructed into lower-resolution images while the lower-resolution residual images subjected to the inverse low-pass filtering are compared with the unified original-resolution residual images to generate original-resolution high frequency residual images, original-resolution referred images obtained by low pass filtering a referred frame created by inverse motion compensation for the original resolution are compared with the reconstructed low pass filtered images, and the images subjected to the comparing are combined with the original-resolution high frequency residual images to generate original-resolution residual images that are then subjected to inverse motion compensation and reconstructed into original-resolution images.

According to another aspect of the present invention, there is provided a scalable video decoder comprising a bitstream interpreter interpreting a received bitstream and extracting coded image data and motion vectors for an original resolution and lower resolution levels from the bitstream, an inverse quantizer separating and inversely quantizing the coded image data to generate original-resolution high-frequency transformed images and lower-resolution transformed images corresponding to the original-resolution high-frequency transformed images, an inverse spatial redundancy remover performing an inverse wavelet, transform on each of the original-resolution high-frequency transformed images and its lower-resolution transformed images to generate original-resolution high frequency residual images and lower-resolution residual images, and an inverse temporal redundancy remover performing inverse motion compensation on the lower-resolution residual images using the lower-resolution motion vectors to reconstruct lower-resolution images, generating original-resolution residual images from the original-resolution high frequency residual images using the lower-resolution residual images, and performing inverse motion compensation on the original-resolution residual images using the original-resolution motion vectors to reconstruct original-resolution images.

### BRIEF DESCRIPTION OF THE DRAWINGS

The above and other features and advantages of the present invention will become more apparent by describing in detail exemplary embodiments thereof with reference to the attached drawings in which:

FIG. 1A is a schematic block diagram of a motion compensated temporal filtering (MCTF)-based scalable video encoder;

FIG. 1B is a schematic block diagram of an in-band scalable video encoder designed to perform a wavelet transform before temporal filtering;

FIG. 2A shows scalable video coding and decoding processes using a MCTF algorithm;

FIG. 2B shows scalable video coding and decoding processes using a successive temporal approximation and referencing (STAR) algorithm;

FIG. 3 is a diagram for explaining wavelet-based video coding for supporting spatial scalability;

FIG. 4 is a functional block diagram schematically showing the configuration of a scalable video encoder according to an embodiment of the present invention;

FIG. 5 is a block diagram showing the detailed configuration of the S1 shown in FIG. 4;

FIG. 6 illustrates various prediction modes for generating a referred image according to an embodiment of the present invention;

FIG. 7 is a block diagram showing the detailed configuration of the spatial redundancy remover shown in FIG. 4;

FIG. 8 is a diagram for explaining a process for creating a unified transformed image with the original resolution;

FIG. 9 is a detailed block diagram of an inverse quantizer according to a first embodiment of the present invention;

FIG. 10 is a detailed block diagram of an inverse temporal redundancy remover according to a first embodiment of the present invention;

FIG. 11 is a diagram showing a process of demultiplexing a coded image into images with respective resolution levels during inverse quantization according to a first embodiment of the present invention;

FIG. 12 is a diagram showing a process of reconstructing an original image according to a first embodiment of the present invention;

FIG. 13 is a detailed block diagram of an inverse quantizer according to a second embodiment of the present invention;

FIG. 14 is a detailed block diagram of an inverse temporal redundancy remover according to a second embodiment of the present invention;

FIG. 15 is a diagram showing a process of generating high frequency residual images after performing inverse quantization and inverse spatial redundancy removal according to a second embodiment of the present invention; and

FIG. 16 is a functional block diagram schematically showing the configuration of a scalable video decoder according to an embodiment of the present invention.

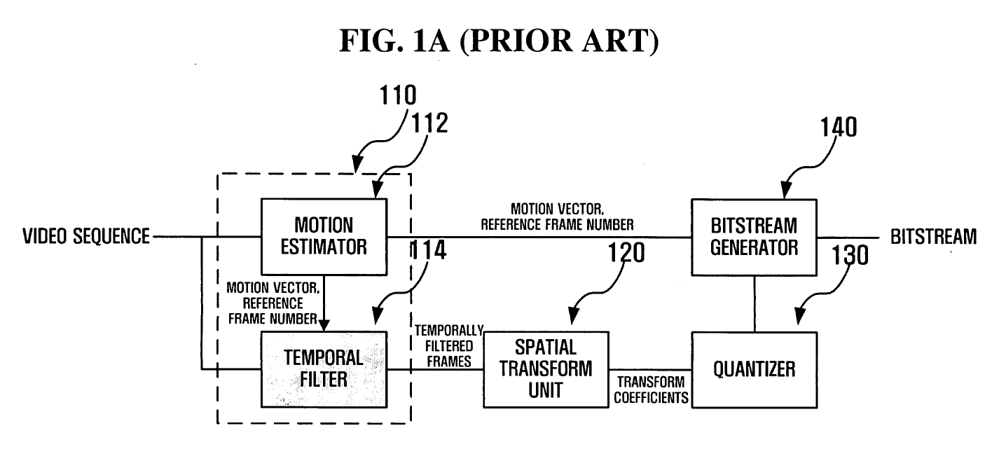

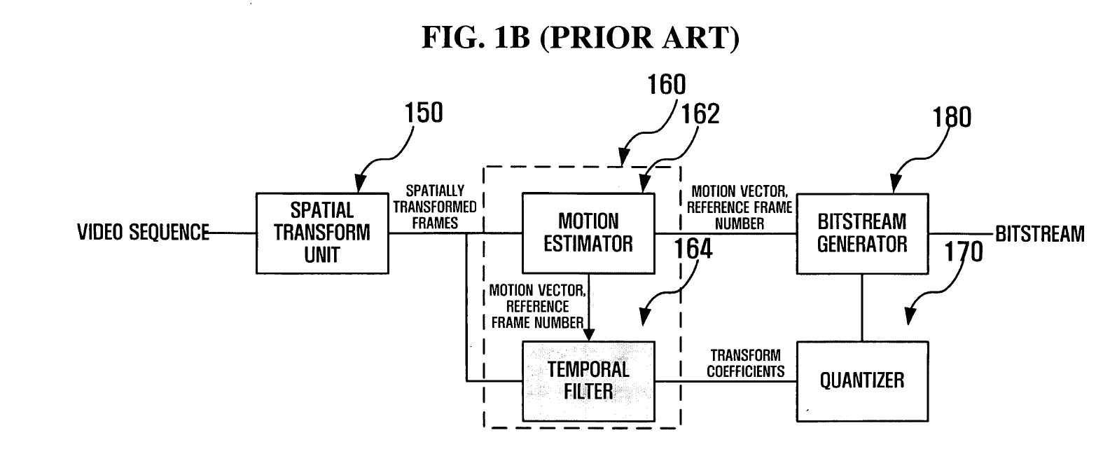

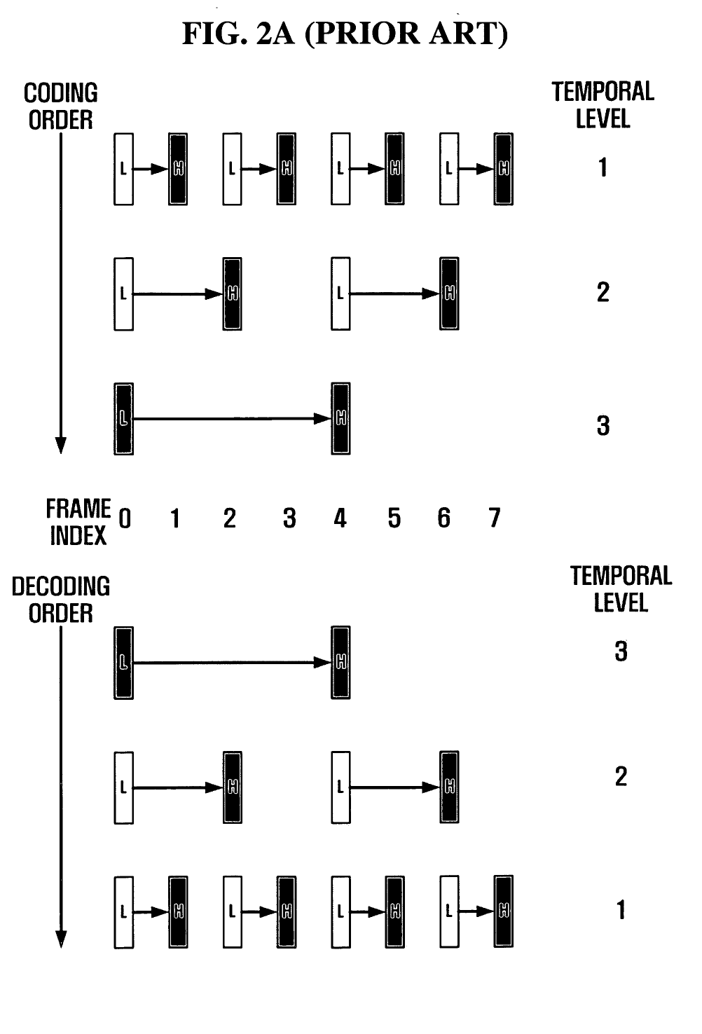

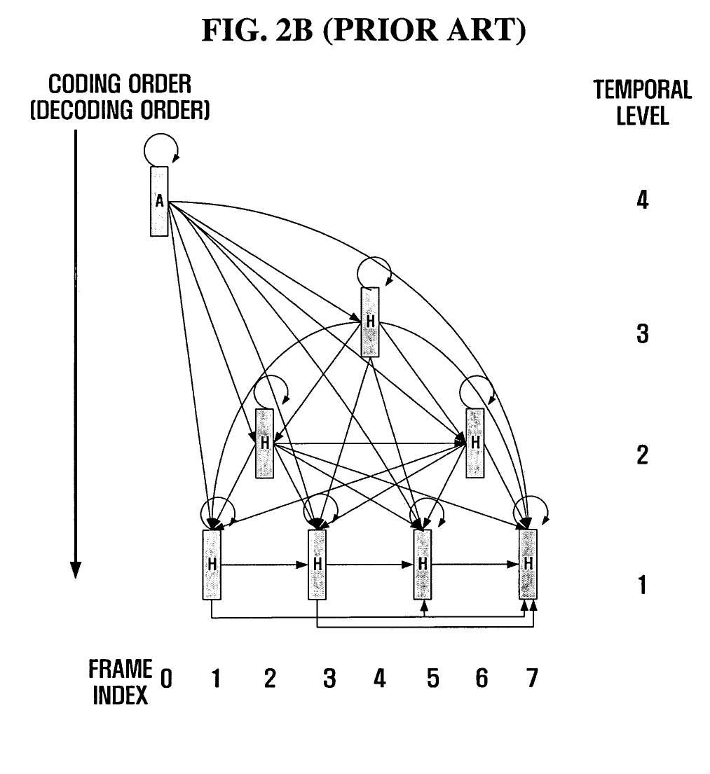

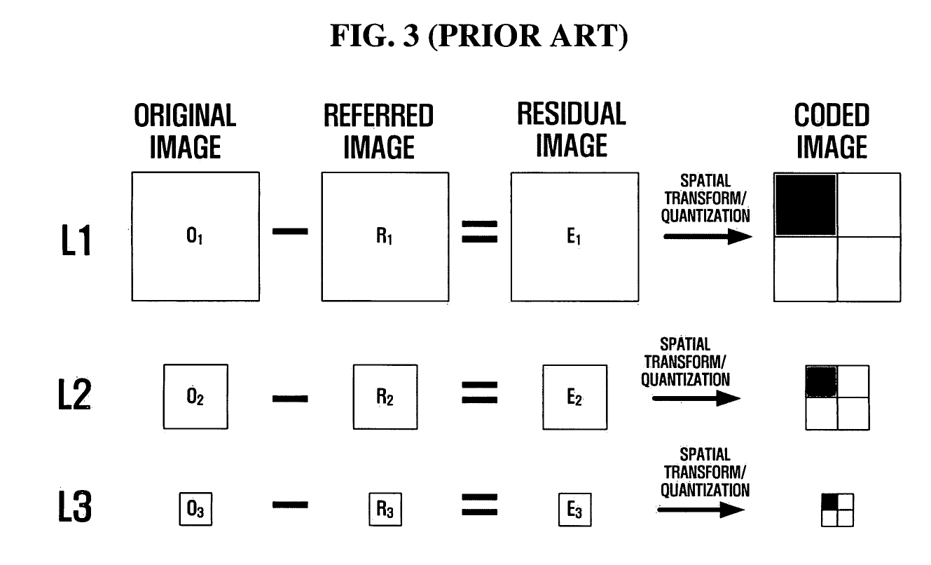

### DETAILED DESCRIPTION OF THE INVENTION

The present invention will now be described more fully with reference to the accompanying drawings, in which exemplary embodiments of the invention are shown. While the present invention will be described with reference to a video coding scheme to generate a bitstream having three resolution levels, the invention will not be limited thereto. For the sake of convenience, the present invention describes coding and decoding of the highest-resolution image of Layer 1, medium-resolution image of Layer 2, and lowest-resolution image of Layer L3. In exemplary embodiments, coding and decoding of a frame (image) will be described.

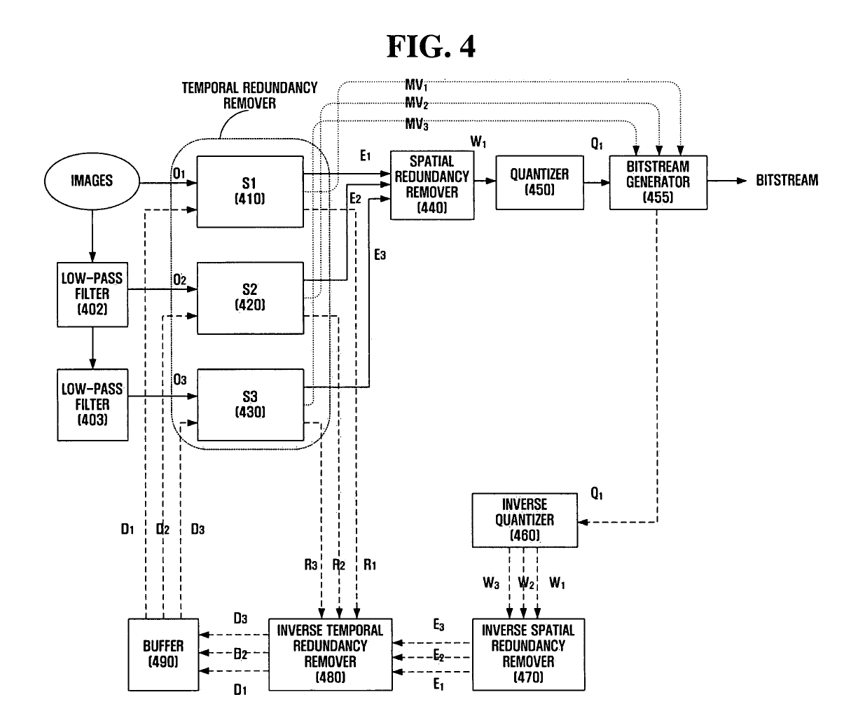

FIG. 4 is a functional block diagram schematically showing the configuration of a scalable video encoder according to an embodiment of the present invention.

Referring to FIG. 4, a scalable video encoder according to an embodiment of the present invention obtains lower-resolution images O₂ and O₃ using a low-pass filter 402 extracting the lower-resolution image O₂ of Layer 2 from the original-resolution image O₁ and a low-pass filter 403 extracting the lower-resolution image O₃ of Layer 3 from the lower-resolution image O₂ of Layer 2. In the illustrative embodiment, low-pass filtering is performed by downsampling using a wavelet 9-7 filter.

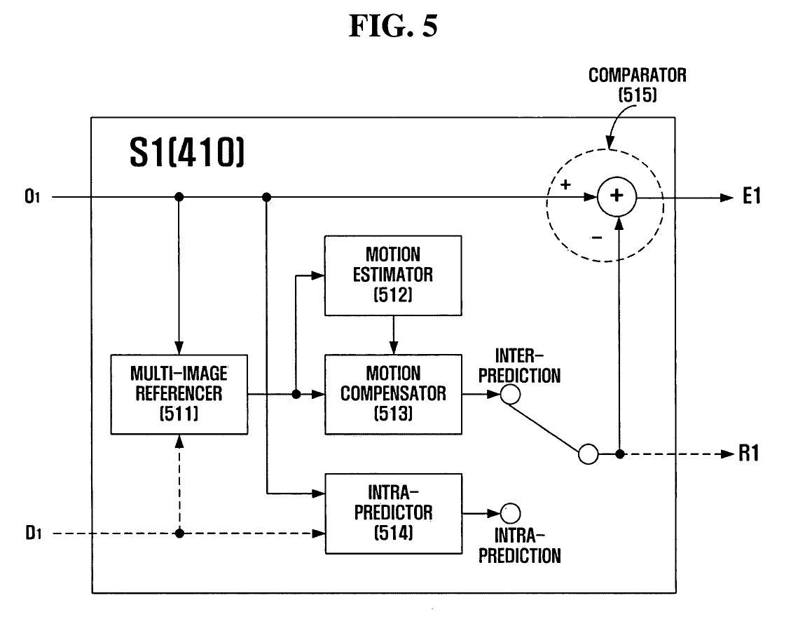

A temporal redundancy remover removes temporal redundancies from the original-resolution image O₁, and lower-resolution images O₂, O₃ with the respective resolution levels in order to generate residual images E₁ through E₃ with the respective resolution levels. S1 410, S2 420, and S3 430 in the temporal redundancy remover all have the same structure and remove temporal redundancies for the respective resolution levels. The detailed structure of the S1 410 will be described later with reference to FIG. 5.

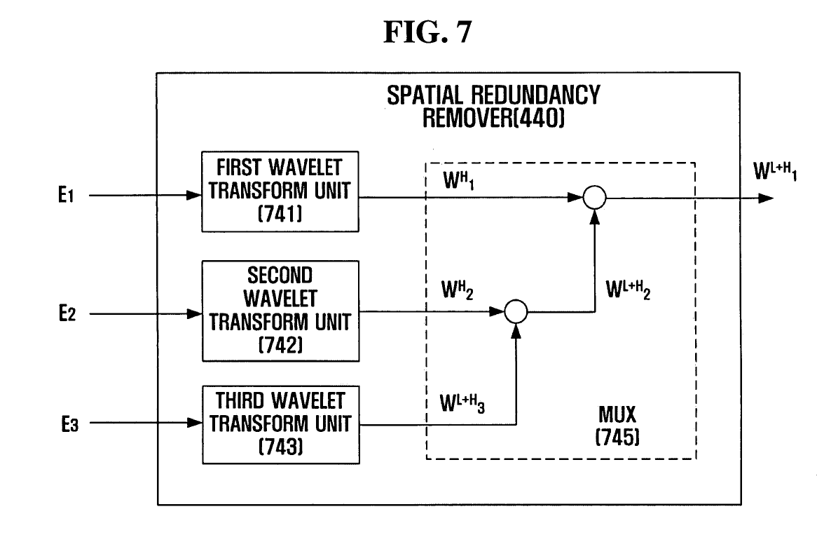

Spatial redundancies are removed from the residual images E₁ through E₃ with the respective resolution levels by a spatial redundancy remover 440 and combined into a unified, transformed image W₁. The detailed structure of the spatial redundancy remover 440 will be described later with reference to FIG. 7.

A quantizer 450 quantizes the unified, transformed image W₁ to create a coded image Q₁. A bitstream generator 455 generates a bitstream by combining the coded images obtained by encoding the input images with motion vectors MV₁, MV₂, and MV₃ for the respective resolution levels obtained by removing the temporal redundancies. The bitstream contains information about the coded images (coded image data), the motion vectors MV₁, MV₂, and MV₃, and other necessary header information.

Meanwhile, when a low frequency subband (L frame) is generated by updating a frame while removing temporal redundancies like in conventional motion compensated temporal filtering (MCTF)-based video coding, images referenced in removing the temporal redundancies are original images making up a video sequence. However, a video coding scheme based on unconstrained MCTF (UMCTF) or successive temporal approximation and referencing (STAR) does not include an update of A- or I-frames. In this successive coding algorithm, images referenced in removing temporal redundancies may be original images making up an input video sequence or images obtained by decoding coded images. In particular, in the latter case, coding and decoding processes form a single loop in a video encoder and are performed in an iterative fashion, which is called a “closed loop” scheme.

In an open loop scheme where original images are referenced at an encoder side in removing temporal redundancies while decoded images are referenced at a decoder side in removing inverse temporal redundancies, a drift error tends to occur. In contrast to the open loop scheme, a closed loop scheme is not subjected to drift error since decoded images are referenced at both encoder and decoder sides. It should be noted that referenced images to be described below may be original images (uncoded images) or decoded images obtained by decoding coded images.

A closed-loop scheme will now be described with reference to FIG. 4.

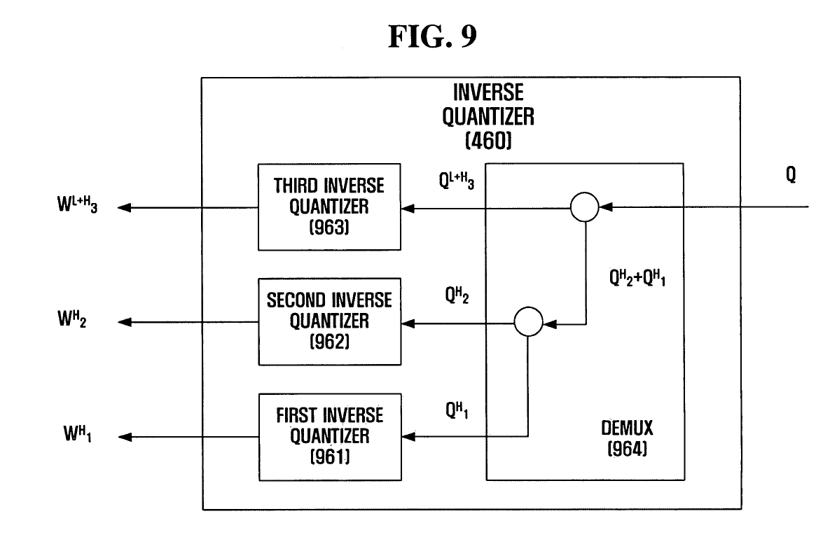

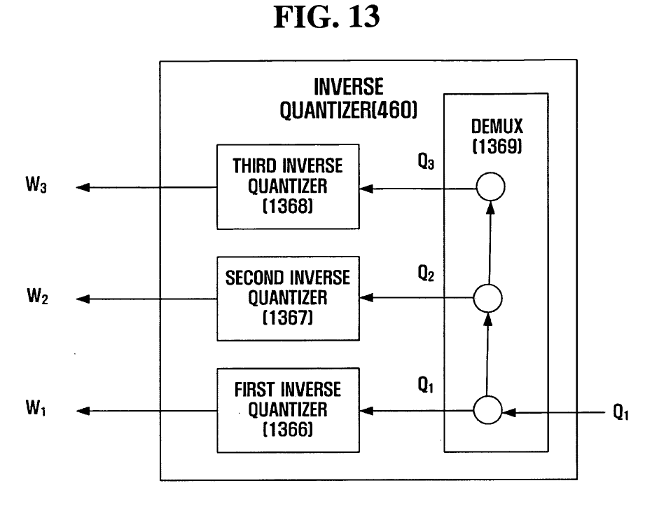

Referring to FIG. 4, the coded image Q₁ is separated and inversely quantized by an inverse quantizer 460 to generate transformed images W₁ through W₃ with the respective resolution levels. The detailed structure of the inverse quantizer 460 will be described later with reference to FIGS. 9 and 13.

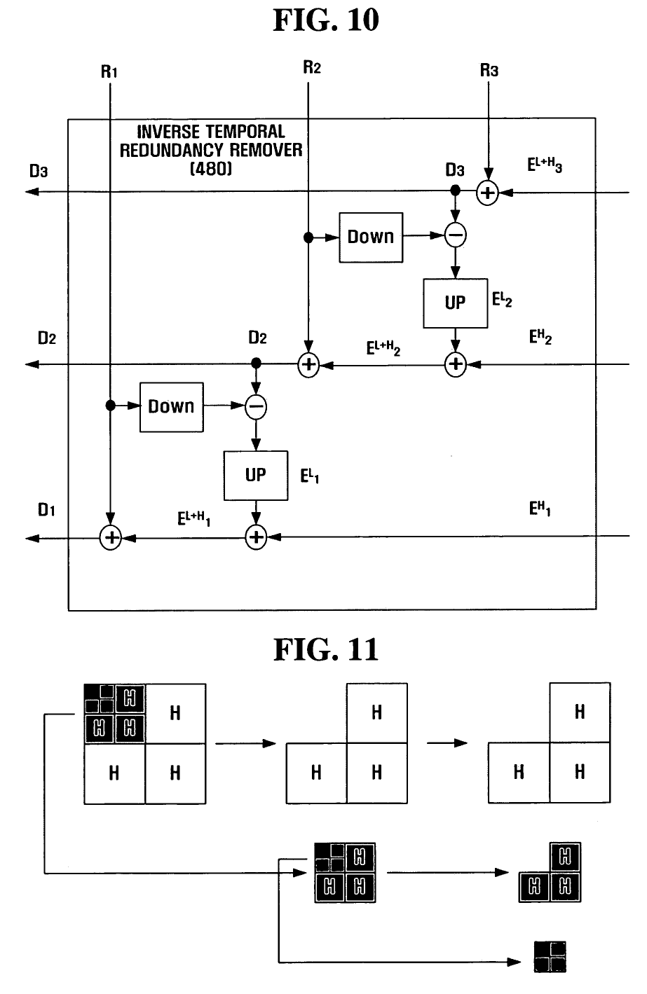

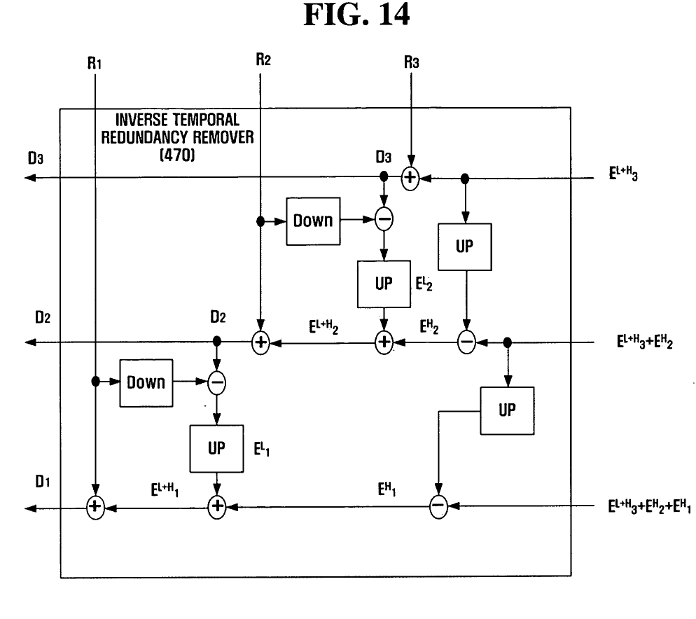

The transformed images W₁ through W₃ with the respective resolution levels are then converted into residual images E₁ through E₃ with the respective resolution levels as they pass through an inverse spatial redundancy remover 470. The residual images E₁ through E₃ with the respective resolution levels are converted into decoded images D₁ through D₃ with the respective resolution levels by an inverse temporal redundancy remover 480. The decoded images D₁ through D₃ are stored in a buffer 490 and provided as referenced images for removing temporal redundancies from a future image. The detailed structure of the inverse temporal redundancy remover 480 will be described later with reference to FIGS. 10 and 14.

Scalable video coding is performed in units of group of pictures (GOP) for temporal scalability. In a conventional MCTF scheme, MCTF is performed on all images in a GOP to generate one low frequency subband (L image) and a plurality of high frequency subbands (H images). In an UMCTF or STAR scheme, one image in a GOP is encoded as an A- or I-image without being subjected to MCTF while the remaining images are subjected to motion compensation with reference to one or a plurality of images to obtain residual images. The temporal redundancies are removed in blocks of predetermined size forming an image.

FIG. 5 is a block diagram showing the detailed configuration of the S1 410 shown in FIG. 4.

Referring to FIG. 5, a motion estimator 512 performs motion estimation on the input image O₁ by referencing one or a plurality of images stored in a multi-image referencer 511 in order to generate motion vectors that are then provided to a motion compensator 513. The motion compensator 513 creates a referred frame R₁ using the input image O₁ and the one or the plurality of referenced images. A comparator 515 compares the input image O₁ with the referred frame R₁ to generate a residual image E₁. All blocks in the referred frame R₁ used for deriving the residual image E₁ from the input image O₁ may be obtained using inter-prediction in the motion compensator 513. Alternatively, some or all of the blocks in the referred frame R₁ may be obtained by performing intra-prediction with reference to the input image O₁ in an intra-predictor 514.

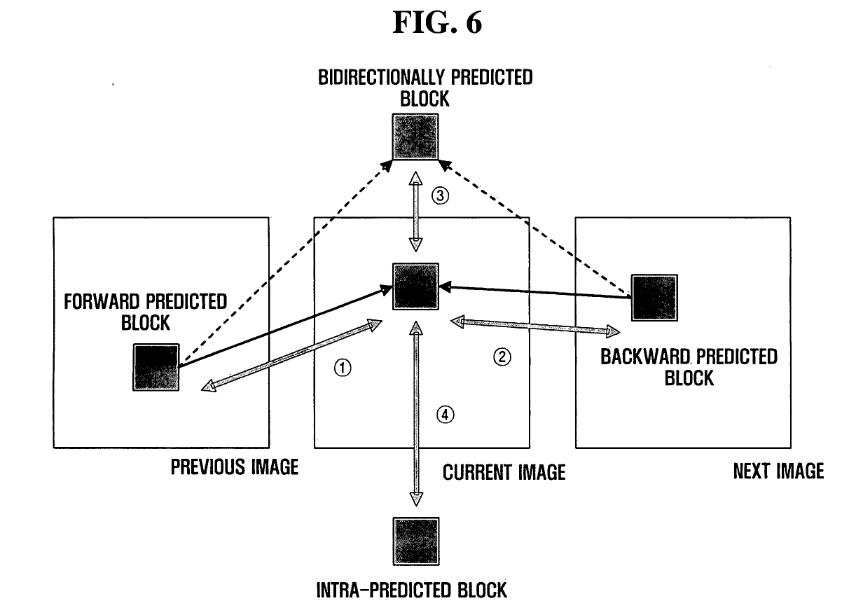

FIG. 6 shows various prediction modes that can be chosen for creating a referred image according to an embodiment of the present invention.

A scalable video encoder of the present invention may use only forward prediction like a conventional MCTF-based encoder, backward and bi-directional predictions like an UMCTF- or STAR-based encoder, or an intra-prediction mode like in a STAR algorithm.

First, a choice of inter-prediction modes will be described.

Since the present invention allows referencing of a plurality of images, it is easy to perform forward, backward, and bi-directional predictions. Inter-prediction may employ a well-known hierarchical variable size block matching (HVSBM) algorithm or fixed block size motion estimation like in the illustrative embodiment. When E(k, −1), B(k, −1), and E(k, *) respectively denote sums of absolute difference (SADs) from forward, backward, and bi-directional predictions of a k-th block, and B(k, −1), B(k, +1), and B(k, *) respectively denote a total number of bits to be allocated for quantizing forward, backward, and bi-directional motion vectors for the k-th block, costs C_{f}, C_{b}, and C_{bi} for forward, backward, and bi-directional prediction modes are defined by Equation (1):
C_{f}=E(k, −1)+λB(k, −1),
C_{b}=E(k, 1)+λB(k, 1),
C_{bi}=E(k, *)+λ{B(k, *)} (1)
where λ is a Lagrange coefficient used to control balance between motion bits and texture (image) bits. Since a final bit rate is not known in a scalable video encoder, λ may be selected according to characteristics of a video sequence and a bit rate that are mainly used in a target application. An optimal inter-estimation mode can be determined for each macroblock based on minimum cost obtained using Equation (1).

Next, a choice of an intra-prediction mode will be described.

In some video sequences, scenes change very fast. In an extreme case, a frame that has no temporal redundancy compared to adjacent frames may be found. To handle such frame, a concept of a macroblock obtained through intra-estimation that is used in a standard hybrid encoder is employed. Generally, an open-loop codec cannot use adjacent macroblock information due to estimation drift. However, a hybrid codec can use an intra-estimation mode. In the present embodiment, DC prediction is used to perform intra-prediction. In the DC prediction mode, a block is intra-predicted by DC values of its Y, U, and V components. If cost for the intra-prediction mode is lower than cost for the best inter-prediction mode mentioned above, the intra-prediction mode is selected. In this case, the difference between the original pixel and DC value is then coded, and the differences between the three DC values are coded instead of motion vectors.

Cost Cᵢ for intra-prediction mode is defined by Equation (2):
Cᵢ=E(k, 0)+λB(k, 0) (2)
where E(k, 0) is a SAD (differences between the original luminance value and DC values) for intra-prediction of a k-th block and B(k, 0) is a total number of bits for coding the three DC values.

If the cost Cᵢ is lower than those defined by Equation (1), the given block is encoded using the intra-prediction mode.

As described above, the spatial redundancy remover 440 removes spatial redundancies from the residual images E1 through E3 with the respective resolution levels from which temporal redundancies have been removed, which will be described with reference to FIG. 7.

FIG. 7 is a detailed block diagram of the spatial redundancy remover 440.

The spatial redundancy remover 440 includes first through third wavelet transform units 741 through 743 performing an inverse wavelet transform on the residual images E₁ through E₃ with the respective resolution levels to remove spatial redundancies and a multiplexer (MUX) 745 combining transformed images W^{H}₁, W^{H}₂, and W^{L+H}₃ with the respective resolution levels subjected to the inverse wavelet transform by the first through third wavelet transform units 741 through 743 into a single unified transformed image W^{L+H}₁.

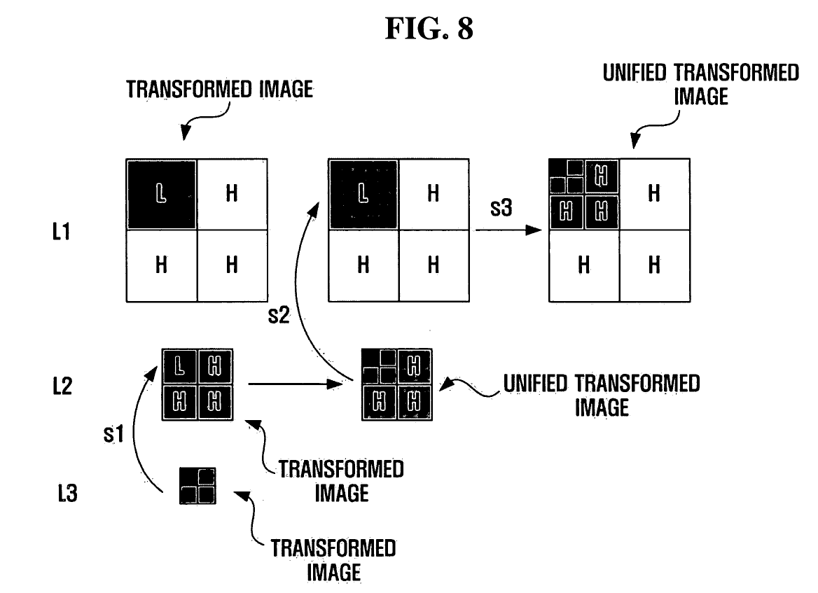

FIG. 8 is a diagram for explaining a process for creating a unified transformed image with the original resolution.

Referring to FIG. 8, the residual images E₁ through E₃ with the respective resolution levels are subjected to the wavelet transform to generate transformed images. Each of the transformed images are decomposed into one low frequency transformed image L that is a reduced size image very similar to the untransformed image and three high-frequency transformed images H. The low frequency transformed image of layer L2 is first replaced with the transformed image of layer L3 to create a unified transformed image of L2 (S1), and then the low frequency transformed image of layer L1 is replaced with the unified transformed image of L2 (S2) to create a unified transformed image of L1 (S3). Alternatively, instead of creating the unified transformed image of L1, the unified transformed image of L2 and the transformed image of L1 may be quantized to generate a bitstream. However, coding efficiency is degraded compared to that provided by the former method since the low frequency transformed image of L1 having spatial redundancy needs to be encoded.

The unified transformed image of L1 is quantized to generate a coded image, and coded image data associated with coded images obtained by encoding a plurality of images in a video sequence is contained in a bitstream.

A process for reconstructing a decoded image from a coded image in a decoder or closed loop encoder will now be described. A process for decoding coded images according to a first embodiment of the present invention is performed as follows:

1. First, a coded low frequency image is separated from the coded image Q₁ of L1 to obtain a coded high frequency image Q^{H}₁ of L1 and a coded image Q₂ of L2. In the same manner, the coded image Q₂ of L2 is separated to obtain a coded high frequency image of L2 and a coded image Q₃ of L3.

2. A process for obtaining a decoded image D₃ of L3 from the coded image Q₃(=Q^{L+H}₃) of L3 is defined by Equation (3):
D₃=DQ_{—}IT[Q^{L+H}₃]+R₃=E^{L+H}₃+R₃ (3)
where DQ_IT[ ] is an inverse quantization function or inverse wavelet transform function and R₃ is a referred image of L3 whose motion is estimated by referencing a plurality of previously decoded images.

3. Then, to obtain a decoded image D₂ of L2, a low frequency residual image E^{L}₂ of L2 replaced by the transformed image W₃ of L3 during encoding is reconstructed using a process defined by Equation (4):
E^{L}₂=D₃−DOWN[R₂] (4)
where DOWN[ ] and R₂ respectively represent a downsampling function and a referred image of L2 whose motion is estimated by referencing a plurality of previously decoded images.

The low frequency residual image E^{L}₂ of L2 can be reconstructed using Equation (4) since DOWN[D₂]−DOWN[R₂]=DOWN[E2] where DOWN[D₂] is D₃ and DOWN[E₂] is E^{L}₂.

Using the low frequency residual image E^{L}₂, a residual image E^{L+H}₂ of L2 is given by Equation (5):
E^{L+H}₂=UP[E^{L}₂]+E^{H}₂ (5)
where UP[ ] denotes an upsampling function. Finally, the decoded image D₂ of L2 is defined by Equation (6):
D₂=E^{L+H}₂+R₂ (6)

In the same manner, a decoded image D₁ of L1 can be obtained using Equations (7) through (9):
E^{L}₁=D₂−DOWN[R₁] (7)

The low frequency residual image E^{L}₁ of L1 can be restored using Equation (7) since DOWN[D₁]−DOWN[R₁]=DOWN[E₁] where DOWN[D₁] is D₂ and DOWN[E₁] is E^{L}₁.

Using the low frequency residual image E^{L}₁, a residual image E^{L+H}₁ of L1 is given by Equation (8):
E^{L+H}₁=UP[E^{L}₁]+E^{H}₁ (8)
Eventually, the decoded image D1 of L1 can be obtained using Equation (9):
D₁=E^{L+H}₁+R₁ (9)

While the resolution of an image has been described above in three resolution levels for L1 through L3, the above-mentioned method can also apply to the image having three or more resolution levels.

The process for decoding coded images according to the first embodiment of the present invention will now be described with reference to FIGS. 9-12. FIGS. 9 and 10 are respectively detailed block diagrams of an inverse quantizer 460 and an inverse temporal redundancy remover 480 according to a first embodiment of the present invention.

Referring to FIG. 9, the inverse quantizer 460 includes a demultiplexer (DEMUX) 964 separating a unified coded image into coded images with the respective resolution levels and first through third inverse quantizers 961 through 963 inversely quantizing the coded images with the respective resolution levels.

The DEMUX 964 separates Q^{L+H}₃ from a unified coded image Q while separating the remaining Q^{H}₂+Q^{H}₁ into Q^{H}₂ and Q^{H}₁. Q^{L+H}₃ may be separated from the unified coded image Q, followed by separation of Q^{H}₂+Q^{H}₁. Otherwise, after separation Q^{H}₁, Q^{H}₂+Q^{L+H}₃ may be separated into Q^{H}₂ and Q^{L+H}₃.

The separated Q^{L+H}₃, Q^{H}₂, and Q^{H}₁ are respectively subjected to inverse quantization by the third, second, and first inverse quantizers 963, 962, and 961 to generate a transformed image W^{L+H}₃ of L3, a high-frequency transformed image W^{H}₂ of L2, and a high-frequency transformed image W^{H}₁ of L1.

The transformed images W^{H}₁, W^{H}₂, and W^{L+H}₃ with the respective resolution levels for L1, L2, and L3 are input to the inverse spatial redundancy remover 470 to produce residual images E^{H}₁, E^{H}₂, and E^{L+H}₃ with the respective resolution levels for L1, L2, and L3 that is then input to the inverse temporal redundancy remover 480 to generate decoded images D₁, D₂, and D₃ with the respective resolution levels for L1, L2, and L3.

More specifically, the decoded image D3 is obtained by adding the residual image E^{L+H}₃ to referred image R₃. The decoded image D₃ is used to produce the decoded image D₂. Specifically, after calculating E^{L}₂ by subtracting the result obtained after downsampling referred image R₂ from the decoded image D₃, the residual image E^{L+H}₂ is calculated by adding residual image E^{H}₂ to the result obtained by upsampling the residual image E^{L+H}₂. Then, the decoded image D₂ is obtained by adding the residual image E^{L+H}₂ to referred image R₂. Similarly, the decoded image D₂ is used to produce the decoded image D1. That is, after calculating E^{L}₁ by subtracting the result obtained after downsampling referred image R₁ from the decoded image D₂, the residual image E^{L+H}₁ is calculated by adding residual image E^{H}₁ to the result obtained by upsampling the residual image E^{L}₁. Then, the decoded image D₁ is obtained by adding the residual image E^{L+H}₁ to referred image R₁. The referred images R₁, R₂, and R₃ are respectively obtained by performing motion estimation using motion vectors for the resolution levels L1, L2, and L3. In this way, the present invention provides a high quality image at each resolution using the highest resolution image and motion vectors for the respective resolution levels.

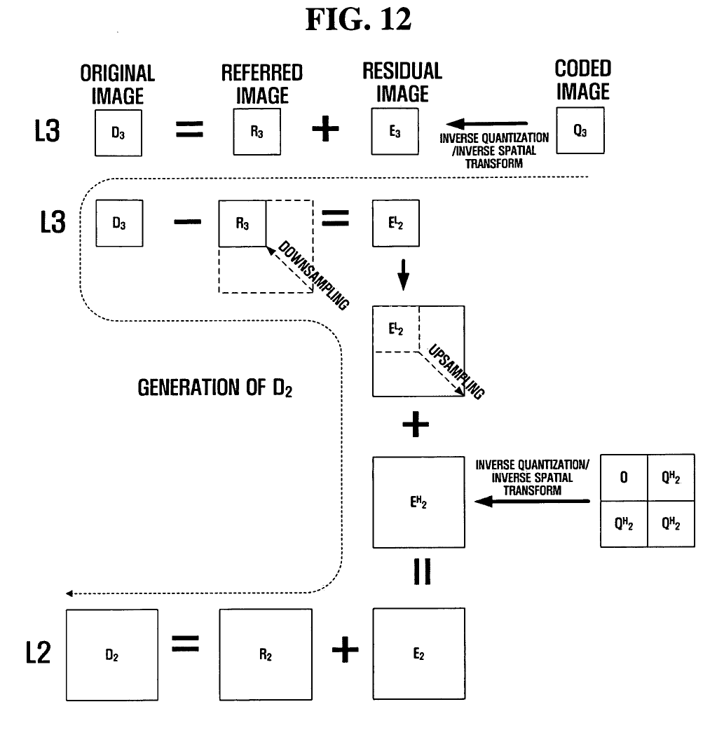

FIG. 11 is a diagram showing an inverse quantization process in which a unified coded image is decomposed into the lowest resolution coded image and high frequency coded image with the higher resolution levels according to a first embodiment of the present invention, and FIG. 12 is a diagram showing a process for reconstructing an original image, i.e., decoded image D₂ using the decoded image D₃ according to a first embodiment of the present invention.

While coded images with the respective images can be obtained by the inverse quantization process according to the first embodiment of the present invention, it may be actually difficult to separate Q^{L+H}₃ from a unified coded image Q while separating the remaining Q^{H}₂+Q^{H}₁ into Q^{H}₂ and Q^{H}₁. In this case, coded images Q₂ and Q₃ may be obtained from the coded image Q (=Q₁) because a scalable video stream is inherently separated into images according to resolution. That is, while the method according to the first embodiment can apply to a bitstream generated to separate a high frequency coded image, the latter method can apply to other common bitstreams, which will be described below with reference to FIGS. 13 and 14.

FIGS. 13 and 14 are respectively detailed block diagrams of an inverse quantizer 460 and an inverse temporal redundancy remover 470 according to a second embodiment of the present invention.

While it is easy to obtain decoded image D₃ using coded image Q₃, only images similar to decoded images D₁ and D₂ can be obtained using unified coded images Q₁ and Q₂ because low frequency components in the coded images Q₁ and Q₂ originate from coded images of L2 and L3, respectively. Thus, the basic idea of the present embodiment is that the decoded images D₁, and D₂ are obtained in the same manner as described in the first embodiment after obtaining residual images E^{H}₁ and E^{H}₂ from the coded images Q₁ and Q₂.

Referring to FIG. 13, the inverse quantizer 460 includes a DEMUX 1369 separating a unified coded image into coded images with the respective resolution levels and first through third inverse quantizers 1366 through 1368 generating unified transformed images from the unified coded images Q₁ through Q₃ with the respective resolution levels. The inverse quantizer 460 converts the unified coded images Q₁ through Q₃ into the unified transformed images W₁ through W₃, respectively, which are then converted into unified residual image E^{L+H}₃+E^{H}₂+E^{H}₁ of L1, unified residual image E^{L+H}₃+E^{H}₂ of L2, and residual image E^{L+H}₃ of L3.

Referring to FIG. 14, a high frequency residual image E^{H}₂ of L2 is obtained by subtracting the result obtained after upsampling the residual image E^{L+H}₃ of L3 from the unified residual image E^{L+H}₃+E^{H}₂ of L2. The upsampling operation is accomplished in order to adjust the resolution.

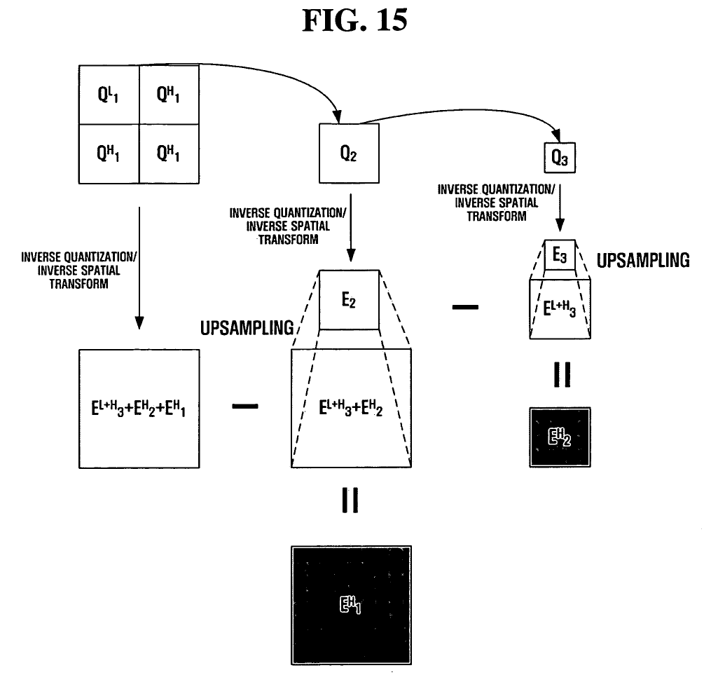

In the same way, a high frequency residual image E^{H}₁ of L1 is obtained by subtracting the result obtained after upsampling the unified residual image E^{L+H}₃+E^{H}₂ of L2 from the unified residual image E^{L+H}₃+E^{H}₂+E^{H}₁ of L1. Original images (decoded images) can be obtained by the process described in the first embodiment. FIG. 15 shows a detailed process of obtaining the high frequency residual images E^{H}₁ and E^{H}₂.

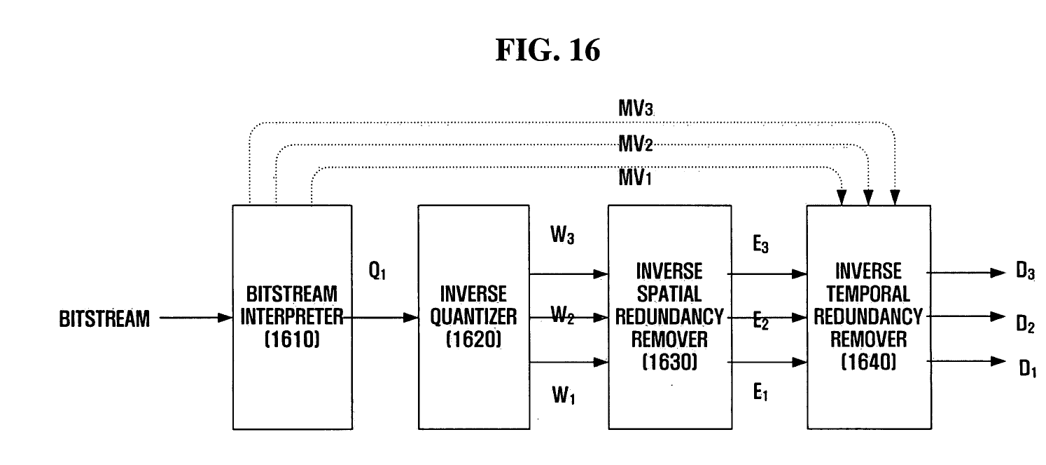

FIG. 16 is a functional block diagram schematically showing the configuration of a scalable video decoder according to an embodiment of the present invention. Referring to FIG. 16, the scalable video decoder includes a bitstream interpreter 1610 receiving a bitstream and interpreting the received bitstream in order to extract unified coded image data and motion vectors for the respective resolution levels, an inverse quantizer 1620 performing inverse quantization on unified coded images contained in the unified coded image data to produce transformed images with the respective resolution levels, an inverse spatial redundancy remover 1630 producing residual images with the respective resolution levels from the transformed images with the respective resolution levels, and an inverse temporal redundancy remover 1640 reconstructing original images through inverse motion compensation using the motion vectors for the respective resolution levels.

The detailed structures and operations of the inverse quantizer 1620, the inverse spatial redundancy remover 1630, and the inverse temporal redundancy remover 1640 are substantially the same as their counterparts in the scalable video encoder described above.

In concluding the detailed description, those skilled in the art will appreciate that many variations and modifications can be made to the preferred embodiments without substantially departing from the principles of the present invention. Therefore, the disclosed preferred embodiments of the invention are used in a generic and descriptive sense only and not for purposes of limitation.

According to the present invention, images with various resolution levels can be combined into a single image while providing high image quality across all resolution levels, thus enabling efficient video coding while fully taking advantage of spatial scalability.

1. A scalable video coding method comprising:
performing low-passing filtering on each of original-resolution images in a video sequence to generate lower-resolution images corresponding to the original-resolution images and removing temporal redundancies from the original-resolution images and the lower-resolution images to generate original-resolution residual images and lower-resolution residual images;
performing a wavelet transform on the original-resolution residual images and the lower-resolution residual images to respectively generate original-resolution transformed images and lower-resolution transformed images and combining the lower-resolution transformed images into the original-resolution transformed images to generate unified original-resolution transformed images; and
quantizing each of the unified original-resolution transformed images to generate coded image data and generating a bitstream containing the coded image data and motion vectors obtained while removing the temporal redundancies from the original-resolution images and the lower-resolution images.

2. The method of claim 1, wherein the low-pass filtering is performed by downsampling using a wavelet 9-7 filter.

3. The method of claim 1, wherein the generated lower-resolution images include first low-resolution images obtained by low-pass filtering each of the original-resolution images and the second low-resolution images obtained by low-pass filtering the first low-resolution images, wherein the original-resolution images and the first and the second low-resolution images are respectively converted into original-resolution transformed images, first low-resolution transformed images, and second low-resolution transformed images after removing the temporal redundancies therefrom, among which the first and the second low-resolution transformed images are then combined together to generate unified first low-resolution transformed images, and the original-resolution transformed images and the unified first low-resolution transformed images are combined together to generate the unified original-resolution transformed images.

4. The method of claim 1, wherein the removing of temporal redundancies is performed at each resolution level, and comprises:
performing motion estimation on each of the original-resolution images and the lower-resolution images to find the motion vectors to be used in removing the temporal redundancies from the original-resolution images and the lower-resolution images by referencing one or more referenced images corresponding to one or more coded images; and
removing temporal redundancies from the original-resolution images and the lower-resolution images by performing motion compensation using the motion vectors obtained by the motion estimation to generate the lower-resolution residual images and the original-resolution residual images.

5. The method of claim 4, wherein the referenced images corresponding to the coded images are obtained by decoding the coded images.

6. The method of claim 4, further comprising referencing the referred images when the temporal redundancies of the low-resolution residual images and the original-resolution residual images are removed.

7. A scalable video encoder comprising:
a temporal redundancy remover removing temporal redundancies from each of original-resolution images and lower-resolution images corresponding to the original-resolution images and respectively generating original-resolution residual images and lower-resolution residual images;
a spatial redundancy remover performing a wavelet transform on the original-resolution residual images and the lower-resolution residual images to respectively generate original-resolution transformed images and lower-resolution transformed images and combining the lower-resolution transformed images into the original-resolution transformed image to generate unified original-resolution transformed images; and
a quantizer quantizing each of the unified original-resolution transformed images to generate coded image data; and
a bitstream generator generating a bitstream containing the coded image data and motion vectors obtained while removing the temporal redundancies from the original-resolution images and the lower-resolution images.

8. The encoder of claim 7, further comprising a plurality of low-pass filters performing low-pass filtering on each of the original-resolution images to generate the lower-resolution images.

9. The encoder of claim 8, wherein the generated lower-resolution images include first low-resolution images obtained by low-pass filtering each of the original-resolution images and second low-resolution images obtained by low-pass filtering the first low-resolution images, wherein the original-resolution images and the first and the second low-resolution images are respectively converted into the original-resolution transformed images and the first and the second low-resolution transformed images by the spatial redundancy remover after the temporal redundancy remover removes the temporal redundancies therefrom, among which the first and the second low-resolution transformed images are then combined together to generate unified first low-resolution transformed images, and the original transformed images and the unified first low-resolution transformed images are combined together to generate the unified original-resolution transformed images.

10. The encoder of claim 7, wherein the temporal redundancy remover removing the temporal redundancies for each of the original-resolution images and the lower-resolution images comprises:
one or more motion estimators finding the motion vectors to be used in removing the temporal redundancies from each of the original-resolution images and the lower-resolution images by referencing one or more referenced images corresponding to the one or more coded images; and
one or more motion compensators performing motion compensation on the original-resolution images and the lower-resolution images using the motion vectors obtained by the motion estimation to generate the original-resolution residual images and the lower-resolution residual images.

11. The encoder of claim 10, further comprising a decoding unit reconstructing the referenced images by decoding the coded images.

12. The encoder of claim 10, wherein the temporal redundancy remover further comprises one or more intra-predictors removing the temporal redundancies from each of the original-resolution images and the lower-resolution images with reference to the referenced images.

13. The encoder of claim 7, wherein the spatial redundancy remover comprises one or more wavelet transform units performing a wavelet transform on the original-resolution residual images and the lower-resolution residual images to respectively generate the original-resolution transformed images and the lower-resolution transformed images and a transformed image combiner that unifies the lower-resolution transformed images into the original-resolution transformed images to generate the unified original-resolution transformed images.

14. A scalable video decoding method comprising:
extracting coded image data from a bitstream, and separating and inversely quantizing the coded image data to generate unified original-resolution transformed images and lower-resolution transformed images corresponding to the unified original-resolution transformed images;
performing an inverse wavelet transform on each of the unified original-resolution transformed images and lower-resolution transformed images to generate unified original-resolution residual images and lower-resolution residual images; and
performing inverse motion compensation on the lower-resolution residual images using lower-resolution motion vectors extracted from the bitstream to reconstruct lower-resolution images and reconstructing original-resolution images from the unified original-resolution residual images using original-resolution motion vectors extracted from the bitstream.

15. The method of claim 14, wherein the generated lower-resolution transformed images includes unified first low-resolution transformed images and second low-resolution transformed images corresponding to the unified first low-resolution transformed images, and
wherein the unified original-resolution transformed images, the unified first low-resolution transformed images, and the second low-resolution transformed images are subjected to the inverse wavelet transform to respectively generate unified original-resolution residual images, unified first low resolution residual images, and second low resolution residual images, and the inverse motion compensation is performed on the second low resolution residual images using second low-resolution motion vectors obtained from the bitstream to reconstruct second low-resolution images and then first low-resolution images are reconstructed from the unified first low resolution residual images using first low-resolution motion vectors extracted from the bitstream.

16. The method of claim 14, wherein the performing of the inverse motion compensation comprises:
reconstructing lower-resolution images by performing the inverse motion compensation on the lower-resolution residual images using the lower-resolution motion vectors;
generating original-resolution high frequency residual image from each of the unified original-resolution residual images using the lower-resolution residual images;
generating original-resolution residual images using referred images created by the inverse motion compensation of the original resolution images using the original-resolution motion vectors and the reconstructed lower-resolution images; and
reconstructing the original-resolution images by performing the inverse motion compensation on the original-resolution residual images using the original-resolution motion vectors.

17. A scalable video decoding method comprising:
extracting coded image data from a bitstream, and separating and inversely quantizing the coded image data to generate original-resolution high-frequency transformed images and lower-resolution transformed images corresponding to the original-resolution high-frequency transformed images;
performing an inverse wavelet transform on each of the original-resolution high-frequency transformed images and corresponding lower-resolution transformed images to generate original-resolution high frequency residual images and lower-resolution residual images; and
performing inverse motion compensation on the lower-resolution residual images using lower-resolution motion vectors extracted from the bitstream to reconstruct lower-resolution images, generating original-resolution residual images from the original high frequency residual images using the reconstructed lower-resolution images, and performing inverse motion compensation on the original-resolution residual images using original-resolution motion vectors extracted from the bitstream to reconstruct original-resolution images.

18. A scalable video decoder comprising:
a bitstream interpreter interpreting a received bitstream and extracting coded image data and motion vectors for an original resolution level and lower resolution levels from the bitstream;
an inverse quantizer separating and inversely quantizing the coded image data to respectively generate unified original-resolution transformed images and lower-resolution transformed images corresponding to the unified original-resolution transformed images;
an inverse spatial redundancy remover performing an inverse wavelet transform on each of the unified original-resolution transformed images and its lower-resolution transformed images to generate unified original-resolution residual images and lower-resolution residual images; and
an inverse temporal redundancy remover performing inverse motion compensation on the lower-resolution residual images using lower-resolution motion vectors extracted from the bitstream to reconstruct lower-resolution images and reconstructing original-resolution images from the unified original-resolution residual images using the reconstructed lower-resolution images and original-resolution motion vectors extracted from the bitstream.

19. The decoder of claim 18, wherein the inverse temporal redundancy remover comprises:
one or more inverse motion compensators performing inverse motion compensation on each of the lower-resolution residual images and the uniform original-resolution residual images using the original-resolution or the lower-resolution motion vectors;
one or more inverse low-pass filters increasing resolution levels; and
one or more low-pass filters decreasing the resolution levels, and
wherein the lower-resolution residual images are reconstructed into lower-resolution images while the lower-resolution residual images subjected to the inverse low-pass filtering are compared with the unified original-resolution residual images to generate original-resolution high frequency residual images, original-resolution referred images obtained by low pass filtering a referred frame created by inverse motion compensation for the original resolution are compared with the reconstructed low pass filtered lower-resolution images, and are combined with the original-resolution high frequency residual images to generate original-resolution residual images that are then subjected to the inverse motion compensation and reconstructed into the original-resolution images.

20. A scalable video decoder comprising:
a bitstream interpreter interpreting a received bitstream and extracting coded image data and motion vectors for an original resolution level and lower resolution levels from the bitstream;
an inverse quantizer separating and inversely quantizing the coded image data to generate original-resolution high-frequency transformed images and lower-resolution transformed images corresponding to the original-resolution high-frequency transformed images;
an inverse spatial redundancy remover performing an inverse wavelet transform on each of the original-resolution high-frequency transformed images and lower-resolution transformed images to generate original-resolution high frequency residual images and lower-resolution residual images; and
an inverse temporal redundancy remover performing inverse motion compensation on the lower-resolution residual images using the lower-resolution motion vectors to reconstruct lower-resolution images, generating original-resolution residual images from the original-resolution high frequency residual images using the lower-resolution residual images, and performing inverse motion compensation on the original-resolution residual images using the original-resolution motion vectors to reconstruct original-resolution images.

21. A recording medium having a computer-readable program recorded thereon for executing the method of scalable video coding, the method comprising:
performing low-passing filtering on each of original-resolution images in a video sequence to generate lower-resolution images corresponding to the original-resolution images and removing temporal redundancies from the original-resolution images and the lower-resolution images to generate original-resolution residual images and lower-resolution residual images;
performing a wavelet transform on the original-resolution residual images and the lower-resolution residual images to respectively generate original-resolution transformed images and lower-resolution transformed images and combining the lower-resolution transformed images into the original-resolution transformed images to generate unified original-resolution transformed images; and
quantizing each of the unified original-resolution transformed images to generate coded image data and generating a bitstream containing the coded image data and motion vectors obtained while removing the temporal redundancies from the original-resolution images and the lower-resolution images.
